(19) United States
(12) Patent Application Publication
(10) Pub. No.: US 2006/0091975 A1
(43) Pub. Date: May 4, 2006

(54) Front-end circuit comprising thin-film resonators

(75) Inventors: Edgar Schmidhammer, Stein (DE); Pasi Tikka, Taufkirchen (DE); Ralph Stoemmer, Neubiberg (DE)

Correspondence Address: FISH & RICHARDSON PC, P.O. BOX 1022, MINNEAPOLIS, MN, 55440-1022, US

(73) Assignee: EPCOS A G, Munich (DE)

(21) Appl. No.: 10/544,095

(22) PCT Filed: Dec. 16, 2003
(86) PCT No.: PCT/EP03/14352

§ 371 Date: Aug. 1, 2005

(30) Foreign Application Priority Data
Feb. 10, 2003 (DE) 103 05 379.4

(51) Int. Cl. H01P 1/213

(52) U.S. Cl. 333/132

(57) ABSTRACT

The invention relates to a front-end circuit, suitable for a plurality of mobile wireless systems, for separating different frequency bands. According to the invention, separation of the frequency bands occurs by means of band-pass filters connected in parallel signal paths and executed on the basis of thin-layer resonators, which, as a result of their high quality, allow for a high degree of selection between the frequency bands.

The invention relates to a front-end circuit for various mobile wireless systems with frequency bands differing from one another.

The separation of the frequency bands in a front-end module for mobile communications can occur by means of, for example, circuit diodes, which constitutes a complex and costly solution.

To separate different frequency bands in a component with a common antenna connection, a frequency shunt (or diplexer) can be used which consists of passive circuit elements. A diplexer is usually connected in the reception path between an antenna and a plurality of receivers, one receiver being preferably provided for each frequency band. The separation of two frequency bands in a component with a common antenna connection can occur by means of the arrangement of a low-pass filter in a first signal path and a high-pass filter in a second signal path arranged in parallel to the first signal path. A reception circuit with a band-pass filter is connected downstream in each signal path of the diplexer formed in this manner, wherein the band-pass filter must often be adjusted to the diplexer by means of an adjustment network, resulting in substantial spatial requirements.

In known components, the diplexer must usually be connected on the input side (in the respective signal) with other components, e.g., with an adjustment network, so as to guarantee a high degree of isolation between the frequency bands. However, the elements of the adjustment network exhibit ohmic losses and generally require a significant amount of space.

A microwave diplexer for processing a polarized signal is known from printed publication EP 0400833 B1, said diplexer having a waveguide and a plurality of band-pass resonator arrays consisting of hollow conductors disposed symmetrically around the circumference of the waveguide. This diplexer can also be used for radar applications at the highest frequencies. Because of increased spatial requirements at mobile wireless frequencies, however, this type of diplexer is not suitable for use in mobile wireless terminals.

The previously known front-end circuits that contain diplexers are characterized by a comparatively high insertion attenuation of the electric signal.

The goal of the present invention is to specify a front-end circuit suitable for a plurality of mobile wireless systems having various frequency bands, said circuit exhibiting a low insertion attenuation.

The invention specifies a front-end circuit for at least two mobile wireless systems having different frequency bands, a frequency band being allocated to each mobile wireless system. The front-end circuit has

a) a common antenna connection arranged on the input side,

b) at least two signal paths arranged in parallel and electrically connected to the antenna connection, and

c) individual electric gates for each signal path, arranged on the output side, said gates being connectable to secondary stage circuits. In this connection, a unique frequency band is assigned to each signal path and a band-pass filter is arranged in each signal path. The band-pass filter essentially contains thin-layer resonators and is directly connected to the antenna connection.

Because of the high quality of the thin-layer resonators, the front-end circuit according to the invention exhibits a low insertion attenuation at high selection (e.g., better than 20 dB) between the bands. According to the invention, it is possible to implement a frequency diplexer by means of one band-pass filter per signal path in a single component that is, without a loss-producing contact point and adjustment network, thereby reducing signal losses.

The multilayer technology in which the thin-layer resonators are designed is advantageous over the comparable SAW technology (SAW=Surface Acoustic Wave), in that the resonant frequency of the resonators is not determined by structures arranged horizontally adjacent to one another, but rather by the layer thicknesses, that is, by the vertical structure of a thin-layer resonator. In this connection, the layer thicknesses, which are generally greater than 10 μm, can be more effectively controlled than the horizontal dimensions of the finger-like electrodes of the SAW components, which amount to approx. 1 μm at normal mobile wireless frequencies.

The thin-layer resonators are premium connected to one another in a ladder-type or lattice-type array. According to the invention, a balun can be connected in at least one of the signal paths. The balun can be connected in at least one of the signal paths between the band-pass filter and the corresponding electric gate, for example.

A balun can be implemented, for example, on the basis of a plurality of thin-layer resonators stacked on top of one another and/or at least acoustically coupled with one another. The compound thin-layer resonators can be connected to one another in such a way that they implement a filter circuit with balun functionality.

In addition to an integrated balun functionality, the circuit according to the invention can also perform other functions. In particular, an impedance transformation can be implemented by means a suitable design.

In addition to thin-layer resonators, other elements, such as capacitors, inductors and lines or line segments, preferably produced during the same process step as the thin-layer resonators, can be integrated into the front-end module according to the invention. The advantage of a compact arrangement of a plurality of components in a module is that feed losses and/or unwanted couplings between the components are reduced.

A front-end circuit according to the invention is characterized by a flexible design with regard to its input and/or output impedance, and is easily adjusted to customer specifications.

In contrast to previously known multiband front-end circuits suitable for the transmission of electric signals in only one direction, the front-end circuit according to the invention allows for the transmission of both reception and transmission signals in a signal path, due to a high edge steepness of the transmission function.

In an advantageous variant of the invention, band-pass filters containing a plurality of thin-layer resonators are connected to form a duplexer, the corresponding signal path having a reception and a transmission path. An LNA (Low Noise Amplifier) can then be connected downstream from the duplexer in the reception path and/or a power amplifier in the transmission path, the entire circuit being implemented as a modular component.

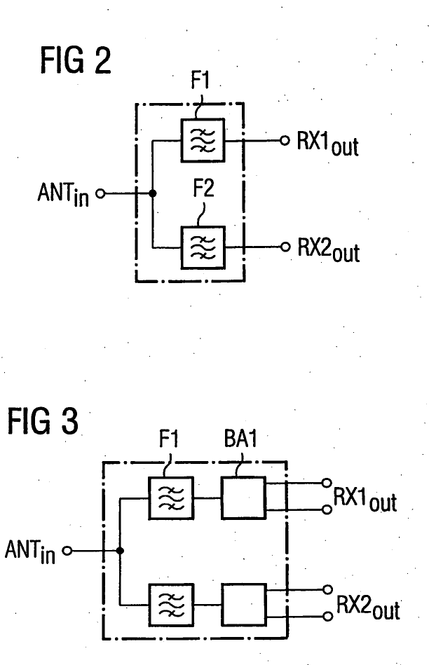

In the following, the invention is explained in detail on the basis of exemplary embodiments and the corresponding figures. FIGS. 2 to 4 show completely or partially different front-end circuits according to the invention.

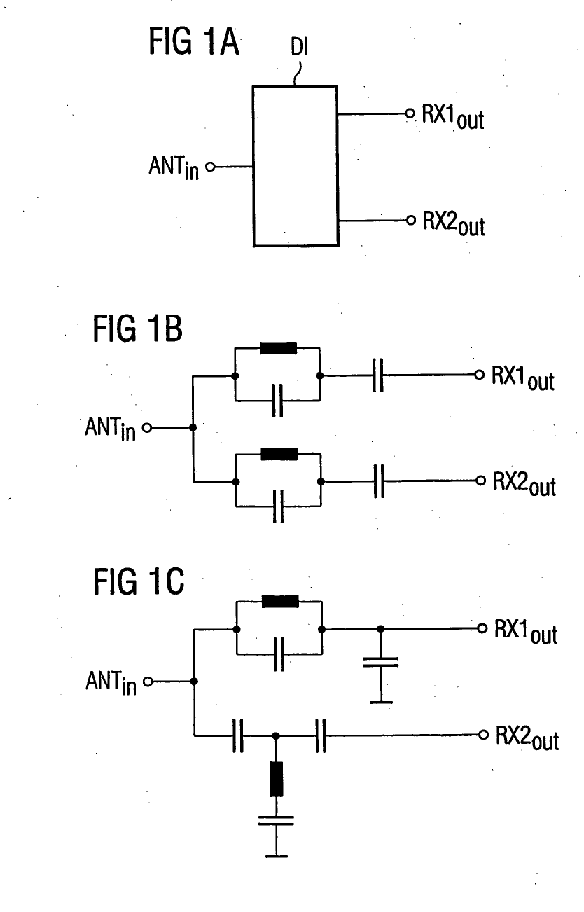

FIG. 1 shows a block diagram of a known front-end circuit (a) and exemplary implementations of a diplexer (b, c)

FIG. 2 shows a front-end circuit according to the invention

FIG. 3 shows a front-end circuit according to the invention with a balun

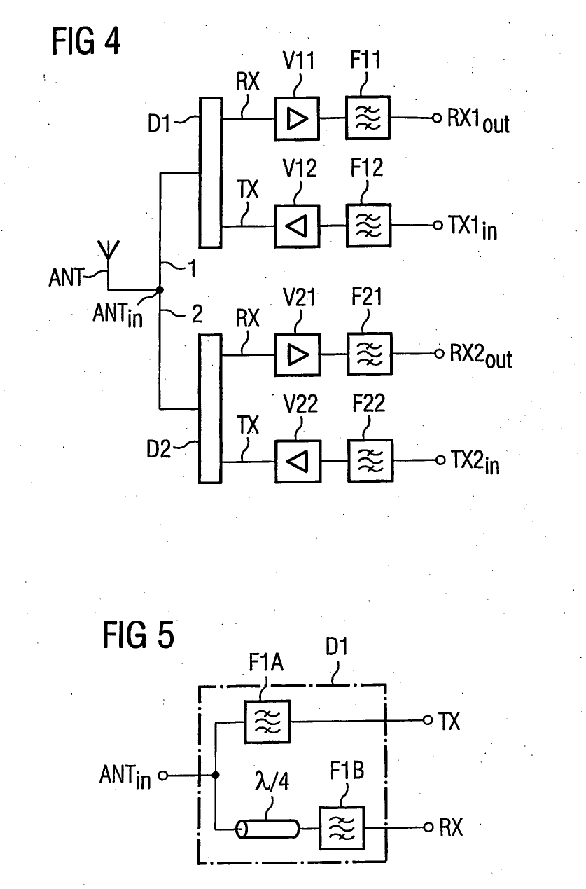

FIG. 4 shows a front-end circuit according to the invention, which is suitable for the transmission of the transmission/reception signals in two frequency bands

FIG. 5 shows an exemplary duplexer circuit

FIG. 1a shows a block diagram of a known front-end module DI (diplexer) with an antenna connection ANTᵢₙ and two output gates RX1ₒᵤₜ and RX2ₒᵤₜ for a first and a second signal path. FIGS. 1b and 1c show exemplary circuits made up of passive elements, which implement a known diplexer.

In FIG. 2, general characteristics of the invention are explained on the basis of a block diagram of a component according to the invention.

A front-end circuit according to the invention is depicted schematically in FIG. 2. The front-end circuit consists of two band-pass filters F1 and F2 connected in parallel and connectable directly to a common antenna.

In the advantageous exemplary embodiment shown in FIG. 3, a balun BA1, BA2 is arranged in each of the signal paths of a front-end module, said balun preferably being designed in the same technology as the band-pass filter F1 and F2.

FIG. 4 shows a front-end module according to the invention, which is suited for the transmission of transmission/reception signals of two mobile wireless systems, e.g., GSM 900 and GSM 1800. The duplexer D1 is arranged in signal path 1 and exhibits the band-pass filters F1A and F1B shown in FIG. 5 and containing a plurality of thin-layer resonators.

Each signal path 1 or 2 is divided into a reception path RX and a transmission path TX, the direction of signal transmission in the two paths RX and TX being opposed. The band-pass filter F1A arranged inside the duplexer D1 in the transmission path TX is directly connected to the antenna connection ANTᵢₙ. The band-pass filter F1B arranged inside the duplexer D1 in the reception path RX is connected to the antenna connection via a λ/4 line. The second duplexer D2 arranged in signal path 2 is structured analogously, but is designed for a different frequency band. Each of the duplexers D1 or D2 is connected directly with the antenna connection.

The transmission frequency of the reception signal of a mobile wireless system generally differs from that of the transmission signal of this mobile wireless system. For this reason, the band-pass filters F1A and F1B have somewhat different center frequencies. Within the meaning of the present invention, however, the transmission and reception bands of the same mobile wireless system, which are close to one another, are viewed as a single frequency band.

An LNA (low noise amplifier) V11 (or V21) is provided in the reception path following the duplexer D1 (or D2), and is connected between the duplexer D1 (or D2) and an additional band-pass filter F11 (or F12).

A power amplifier V12 (or V22) is provided in the transmission path, and is connected between the duplexer D1 (or D2) and an additional band-pass filter F12 (or F22).

In signal paths of the front-end module according to the invention, the reception path RX and/or the transmission path TX can be provided to conduct a symmetrical signal. The balun functionality can be integrated in the duplexer circuit D1 or D2, for example.

In addition to the embodiments of the invention presented in the exemplary embodiments and the corresponding figures, a number of other combinations are also conceivable, which can be obtained by omitting individual components or by combining individual components of the exemplary embodiments described.

1. A circuit configured for use with mobile wireless systems with different frequency bands, the circuit comprising:
an antenna connection,
a first signal path electrically connected to the antenna connection and having an assigned first frequency band, the first signal path comprising:
a first output terminal that is configured to connect to at least one secondary stage circuit; and
a first band-pass filter between the antenna connection and the output terminal, the first band-pass filter comprising thin-layer resonators; and
a second signal path electrically connected to the antenna connection and in parallel with the first signal path, the second signal path having an assigned second frequency band that is different from the first frequency band, the second signal path comprising:
a second output terminal configured connect to at least one secondary stage circuit; and
a second band-pass filter between the antenna connection and the second output terminal, the second band-pass filter comprising thin-layer resonators.

2. The circuit of claim 1, further comprising a balun in at least one of the first and second signal paths.

3. The circuit of claim 2, wherein the balun is connected in at least one of the first and second signal paths between a band-pass filter and an output terminal.

4. The circuit of claim 1, wherein at least one of the first and the second band-pass filters is configured to provide balun functionality.

5. The circuit of claim 1, wherein thin-layer resonators in each of the first and second band-pass filters are stacked to form a compound resonator.

6. The circuit of claim 1, wherein each of the first and the second frequency band is separated from the respective other one with a selectivity of at least about 20 dB.

7. The circuit of claim 1, further comprising a duplexer in at least on of the first and second signal paths, wherein the first signal path comprises a first reception path and a first transmission path and the second signal path comprises a second reception path and a second transmission path.

8. The circuit of claim 7, further comprising a low noise amplifier (LNA) in at least one of the first and second signal paths, the LNA being downstream from the duplexer in a direction of signal propagation.

9. The circuit of claim 8, further comprising
further comprising a power amplifier in at least one of the first and second signal paths, the power amplifier being downstream from the duplexer in a direction of signal propagation.

10. The circuit of claim 1, wherein at least one of the first and the second signal paths is configured to conduct a symmetrical signal.

11. The circuit of claim 1, wherein the thin-layer resonators are acoustically coupled to form a compound resonator.

12. The circuit of claim 7, further comprising an LNA disposed subsequent to a power amplifier in the transmission path.

13. Circuitry comprising:
an antenna;
a first duplexer connected to the antenna;
a second duplexer connected to the antenna;
a first signal path comprising a first transmission path and a first reception path, the first transmission path comprising:
a first input terminal; and
a first band-pass filter between the first duplexer and the first input terminal;
the first reception path comprising:
a first output terminal; and
a second band-pass filter between the first duplexer and the first output terminal; and
a second signal path comprising a second transmission path and a second reception path; the second transmission path comprising:
a second input terminal; and
a third band-pass filter between the second duplexer and the second input terminal;
the second reception path comprising:
a second output terminal; and
a fourth band-pass filter between the second duplexer and the second output terminal.

14. The circuitry of claim 13, further comprising:
a first low noise amplifier (LNA) between the first duplexer and first band-pass filter; and
a second low noise amplifier (LNA) between the first duplexer and third band-pass filter.

15. The circuitry of claim 14, further comprising:
a third low noise amplifier (LNA) between the first duplexer and second band-pass filter; and
a fourth low noise amplifier (LNA) between the first duplexer and fourth band-pass filter.
